(19) United States
(12) Patent Application Publication
(10) Pub. No.: US 2025/0068895 A1
(43) Pub. Date: Feb. 27, 2025

(54) QUANTIZATION METHOD AND APPARATUS FOR ARTIFICIAL NEURAL NETWORK

(71) Applicant: SAMSUNG ELECTRONICS SO., LTD., Suwon-si (KR)

(72) Inventors: Sangwoo PARK, Suwon-si (KR); Taeweon SUH, Seoul (KR)

(73) Assignees: SAMSUNG ELECTRONICS CO., LTD., Suwon-si (KR); KOREA UNIVERSITY RESEARCH AND BUSINESS FOUNDATION, Seoul (KR)

(21) Appl. No.: 18/811,039

(22) Filed: Aug. 21, 2024

(30) Foreign Application Priority Data
Aug. 24, 2023 (KR) 10-2023-0111513

(51) Int. Cl. G06N 3/0495

(52) U.S. Cl. CPC G06N 3/0495

(57) ABSTRACT

Provided are a quantization method and a quantization apparatus for an artificial neural network. The quantization method for the artificial neural network may include estimating sample scale factors of first sample parameters that are part of first parameters within the artificial neural network, determining a prediction scale factor based on the sample scale factors, and quantizing first parameters based on the prediction scale factor.

### CROSS-REFERENCE TO RELATED APPLICATION

This application is based on and claims priority under 35 U.S.C. § 119 to Korean Patent Application No. 10-2023-0111513, filed on Aug. 24, 2023, in the Korean Intellectual Property Office, the disclosure of which is herein incorporated by reference in its entirety.

### BACKGROUND

The inventive concept relates to an artificial neural network, and more particularly, to a quantization method, a quantization apparatus, and a quantization system for an artificial neural network.

An artificial neural network may refer to a computing device or a method performed by the computing device to implement interconnected sets of artificial neurons (or neuron models). Artificial neurons may generate output data by performing simple operations on input data, and the output data may be transmitted to other artificial neurons. As an example of an artificial neural network, a deep neural network or deep learning may have a multi-layered structure.

When dynamic quantization is used in a deep learning inference operation, a scale factor may be required for the input of each layer of a model. Deep learning interference may require a considerable amount of computations when a quantization operation is performed by obtaining scale factors for every input for every layer.

### SUMMARY

The inventive concept provides a quantization method and a quantization apparatus for an artificial neural network, in which high accuracy and low computational complexity of the artificial neural network may be achieved.

According to one or more embodiments, there is provided a quantization method for an artificial neural network, the quantization method including estimating sample scale factors of first sample parameters, the first sample parameters being part of first parameters within the artificial neural network, determining a prediction scale factor based on the sample scale factors, and quantizing first parameters based on the prediction scale factor.

According to one or more embodiments, there is provided a quantization system for an artificial neural network, the quantization system including at least one processor, and a storage medium configured to store commands executable by the at least one processor to perform a quantization process of the artificial neural network, wherein the quantization process of the artificial neural network may include estimating sample scale factors of first sample parameters, the first sample parameters being part of first parameters within the artificial neural network, determining a prediction scale factor based on the sample scale factors, and quantizing first parameters based on the prediction scale factor.

According to one or more embodiments, there is provided a quantization apparatus for an artificial neural network, the quantization apparatus including a scale factor estimator configured to estimate sample scale factors of first sample parameters, the first sample parameters being part of first parameters within the artificial neural network and to determine a prediction scale factor based on the sample scale factors, and a quantizer configured to quantize the first parameters based on the prediction scale factor.

### BRIEF DESCRIPTION OF DRAWINGS

Example embodiments will be more clearly understood from the following detailed description taken in conjunction with the accompanying drawings in which:

FIG. 1 is a block diagram illustrating a quantization system according to an example embodiment;

FIG. 2 is a view illustrating an example of an artificial neural network according to an example embodiment;

FIGS. 3A and 3B are views illustrating a type of quantization method according to an example embodiment;

FIG. 4 is a flowchart illustrating a quantization method for an artificial neural network according to an example embodiment;

FIG. 5 is a block diagram illustrating a quantization apparatus for an artificial neural network according to an example embodiment;

FIG. 6 is a block diagram illustrating a processing device inside the quantization apparatus of FIG. 5 according to an example embodiment;

FIG. 7 is a block diagram illustrating a Quantization with Scale factor Estimation (QSE) unit inside the quantization apparatus of FIG. 5 according to an example embodiment;

FIG. 8 is a block diagram illustrating a computing system according to an example embodiment; and

FIG. 9 is a block diagram illustrating a portable computing system according to an example embodiment.

### DETAILED DESCRIPTION

Hereinafter, example embodiments of the inventive concept will be described in detail with reference to the accompanying drawings.

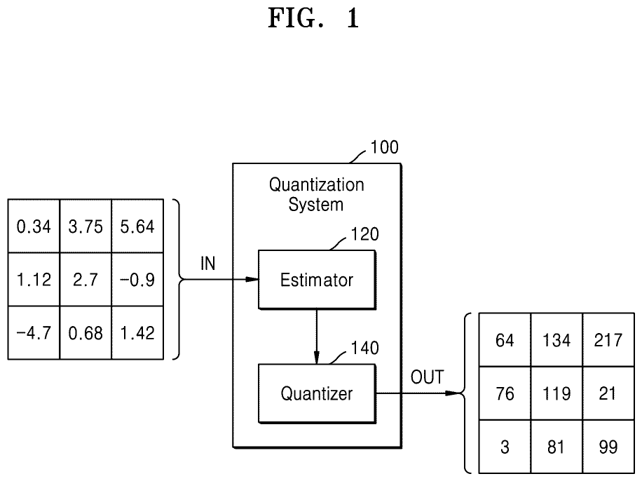

FIG. 1 is a block diagram illustrating a quantization system according to an example embodiment.

FIG. 1 is a block diagram illustrating a quantization system 100 according to an example embodiment. An artificial neural network may refer to a computing system that attempts to simulate a biological neural network in the brain of an animal. In the artificial neural network, performing of a task may be learned by considering a plurality of samples (or examples), which is different from a classical algorithm such as rule-based programming that performs a task according to a pre-defined condition. The artificial neural network may have a structure in which artificial neurons (or neurons) are connected to one another, and connection between the neurons may be referred to as a synapse. The neuron may process a received signal and may transmit the processed signal to another neuron through the synapse. An output of the neuron may be referred to as an activation. The neuron and/or synapse may have a variable weight, and the influence of the signal processed by the neuron may be increased or decreased according to the weight. Also, a bias associated with an individual neuron is applied.

A deep neural network or a deep learning architecture may have a layer structure, and an output of a certain layer may be an input of a subsequent layer. In such a multi-layered structure, each of layers may be trained according to a plurality of samples. The artificial neural network, such as a deep neural network, may be implemented by a number of processing nodes that correspond to artificial neurons, respectively, and high computational complexity may be required to obtain satisfactory results, for example, high accuracy results. Thus, many computing resources may be required.

In order to reduce computational complexity, the artificial neural network may be quantized. Quantization may refer to a process in which input values are mapped to values of a number smaller than the number of the input values, such as mapping real numbers to integers through rounding off. In the artificial neural network, quantization may include a process of converting a floating decimal point neural network into an integer neural network. For example, in the artificial neural network, quantization may be used in an activation, a weight of a layer, or the like. A floating decimal point number may include a sign, an exponent, and a significant, wherein an integer number may include an integer part. In some embodiments, the integer part of the integer number may include a sign bit. Referring to FIG. 1, an input data set IN is expressed in floating decimal point numbers, and an output data set OUT that undergoes a quantization process may be expressed in integer numbers. The artificial neural network using floating decimal point numbers may have high accuracy and computational complexity, while the artificial neural network using integer numbers may have reduced accuracy and less computational complexity.

In the artificial neural network, quantization for the artificial neural network may result in a decrease in accuracy due to the trade-off relationship between the accuracy of results and the computational complexity, and the degree of reduction in accuracy may depend on a method of quantization. Hereinafter, as described below with reference to the accompanying drawings, the quantization system 100 according to an example embodiment may provide quantization according to requirements while minimizing the reduction of accuracy, and thus, a quantized neural network having reduced complexity while having sufficiently high performance may be provided.

The quantization system 100 may be any type of a system that performs quantization according to example embodiments and may also be referred to as a quantization apparatus. For example, the quantization system 100 may be a computing system including at least one processor and at least one memory. As a non-limiting example, the quantization system 100 may be a mobile computing system, such as a laptop computer, a smartphone, or the like, as well as a stationary computing system, such as a desktop computer and a server, or the like. As shown in FIG. 1, the quantization system 100 may include an estimator 120 and a quantizer 140, and each of the estimator 120 and the quantizer 140 may be implemented by a logic block implemented by logic synthesis, a software block performed by a processor, or a combination thereof. In some embodiments, each of the estimator 120 and the quantizer 140 may be a procedure as a set of a plurality of commands executed by a processor, or may be stored in a memory that is accessible by the processor.

Herein, the scale factor estimator 120 and the quantizer 140 may each be analog and/or digital circuits including one or more of a logic gate, an integrated circuit, a microprocessor, a microcontroller, a memory circuit, a passive electronic component, an active electronic component, an optical component, and the like, and may be configured to execute software and/or firmware to perform the corresponding functions or operations described above.

Referring to FIG. 1, the quantization system 100 may receive the input data set IN and may generate the quantized output data set OUT. The input data set IN may include a plurality of pieces of input data, and the quantized output data set OUT may include a plurality of pieces of output data. As shown in FIG. 1, pieces of matrix-type data as the input data set IN may be input to the quantization system 100 according to an example embodiment, and the quantization system 100 may output pieces of matrix-type data as the quantized output data set OUT. Pieces of data according to an example embodiment may include pieces of data of each pixel extracted from an image. Each piece of input data that constitutes the input data set IN may include a floating decimal point number. Each piece of output data that constitutes the output data set OUT to be output through the quantization system 100 may include an integer number. As described below, in the quantization system 100 according to an example embodiment, a computation for determining scale factors for all of inputs in a quantization operation may be omitted and accordingly, the total amount of computations may be reduced.

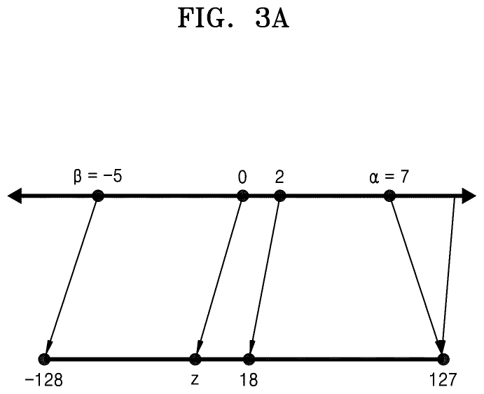

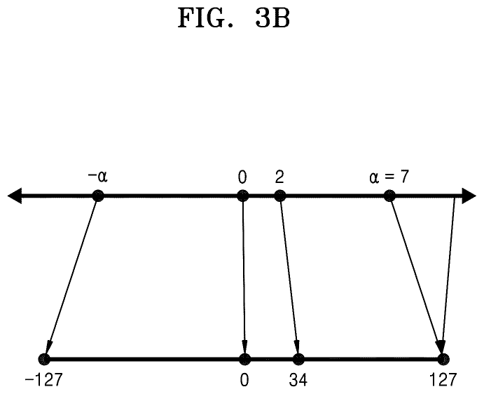

The estimator 120 may receive the input data set IN and may determine a prediction scale factor such as an activation, a weight, or the like to provide the prediction scale factor to the quantizer 140. In order to quantize a floating decimal point number-type variable, a scale factor may be required. The scale factor may indicate a value for mapping a range of a value of data that is being quantized to a quantized range that corresponds to the maximum value and the minimum value that can be represented by the number of bits used in a quantization process. Detailed descriptions of the scale factor will be provided below in detail with reference to FIGS. 3A and 3B. A process of quantizing a variable may be classified into dynamic quantization and static quantization. The quantization system 100 according to an example embodiment may quantize pieces of data by using the dynamic quantization method in which a weight, an activation, or the like in the artificial neural network is quantized in real time in an interference step after learning. Pieces of data to be quantized such as a weight, an activation, or the like in the artificial neural network may be referred to as a parameter for convenience in the present specification. When scale factors are calculated or estimated for all of the parameters to be quantized, the scale factors may have high accuracy but an excessive amount of computations may be required. As described below, the estimator 120 according to an example embodiment may estimate a scale factor for a portion of the parameters to be quantized and may determine a prediction scale factor from the estimated scale factors to provide the determined prediction scale factor to the quantizer 140. That is, the estimator 120 may estimate a scale factor for only a portion of the parameters to be quantized and skip estimating a scale factor for the other portion of the first parameters. Since the quantization system 100 may estimate the scale factor only for a portion of the parameters and not all of the parameters, determine a prediction scale factor based on the estimated scale factors from the portion of the parameters, and perform quantization for the parameters using the prediction scale factor, computation for determining scale factors for all of inputs in a quantization operation during deep learning interference may be omitted and accordingly, the total amount of computations may be reduced.

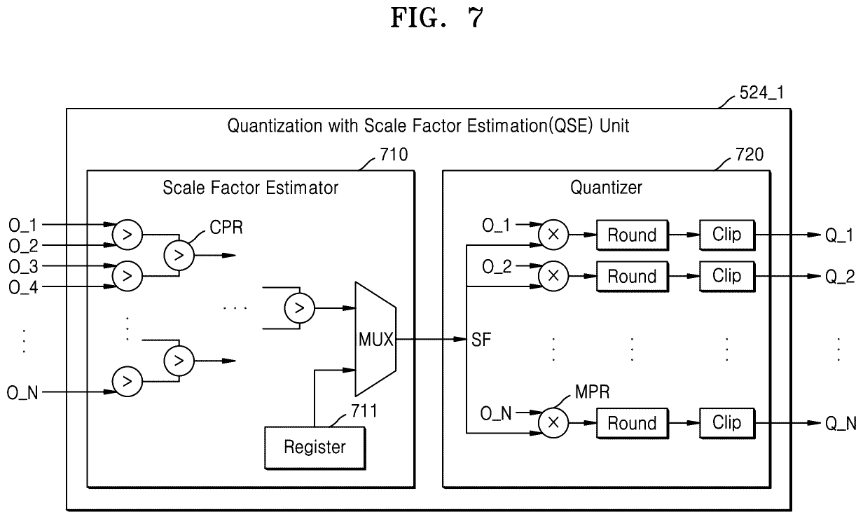

The quantizer 140 may receive the prediction scale factor corresponding to the parameters from the estimator 120 and may quantize the parameters based on the prediction scale factor to generate the quantized output data set OUT. A detailed quantization process of the quantizer 140 will be described below in detail with reference to FIG. 7 or the like.

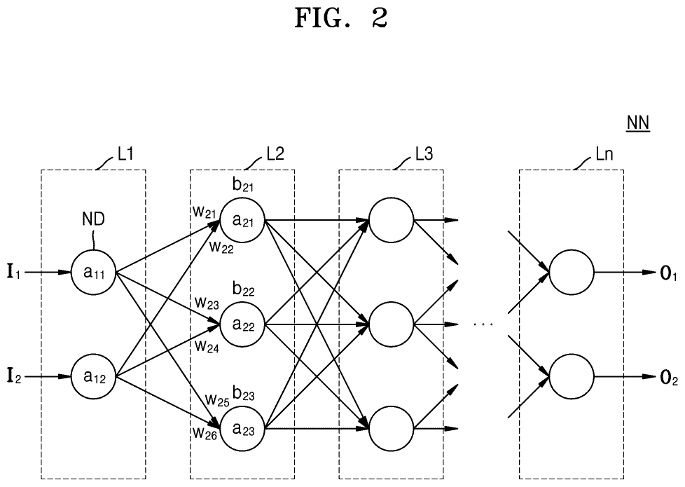

FIG. 2 is a view illustrating an example of an artificial neural network according to an example embodiment.

Referring to FIG. 2, the artificial neural network may have a structure including an input layer L1, hidden layers (L2, L3), and an output layer Ln (where n is a natural number of 3 or more), and operations may be performed based on the received input data (e.g., I₁, I₂), and output data (e.g., O₁, O₂) may be generated based on the result of operations.

The artificial neural network may be a deep neural network including one or more hidden layers, or n-layers neural networks. For example, as shown in FIG. 2, the artificial neural network may be a deep neural network including the input layer L1, the hidden layers L2 and L3, and the output layer Ln. The deep neural network may include a Convolutional Neural Networks (CNN), a Recurrent Neural Networks (RNN), a Deep Belief Network, a Restricted Boltzman Machine, or the like, and example embodiments are not limited thereto.

When the artificial neural network has a deep neural network (DNN) structure, the artificial neural network includes more layers through which valid information may be extracted, such that the artificial neural network may process more complex data sets than in other types of an artificial neural network according to the related art. The artificial neural network may also include layers having various different structures from those shown in FIG. 2.

Each of the layers L1 to Ln included in the artificial neural network may include a plurality of artificial nodes, which are also known as neurons, units or similar terms. For example, as shown in FIG. 2, an input layer L1 may include two nodes ND and hidden layers L2 and L3 may include three nodes ND. However, this is only an example, and each of the layers included in the artificial neural network may include various numbers of nodes ND, and the numbers of the nodes ND included in each layer may be different from each other.

Nodes included in each of the layers included in the artificial neural network may be connected to each other to exchange data. For example, one node ND may receive data from other nodes ND to perform computations and may output the result of computations to other nodes ND.

An input and an output of each of the nodes ND may be referred to as an activation. The activation may be an output value of one node ND and may be an input value of the nodes ND included in the next layer. Each of the nodes ND may determine its own activation based on activations and weights received from the nodes ND included in a previous layer. The weights are network parameters used to calculate the activation in each node ND and may be values allocated to the connection relationship between the nodes ND. For example, in the second layer L2, the nodes ND may determine their own activations based on activations (a₁₁, a₁₂), which are received from the previous layer L1, weights (w₂₁, w₂₂, w₂₃, w₂₄, w₂₅, w₂₆), and biases (b₂₁, b₂₂, b₂₃). Each of the nodes ND may be a computational unit that receives an input and outputs an activation and may perform input-output mapping.

The artificial neural network may include an activation function between the layers. An activation function may convert the output of the previous layer into an input of the next layer. For example, the activation function may be a non-linear function, such as Rectified Linear Unit (ReLU), Parametric Rectified Linear Unit (PReLU), hyperbolic tangent (tan h), sigmoid function, and may convert the output of the second layer L2 non-linearly between the second layer L2 and the third layer L3. The activation may be a value obtained by applying the activation function to a weighted sum of activations received from the previous layer.

Subsequently, referring to FIGS. 1 and 2, an object to be quantized by the quantization system 100 may include activations and weights of the artificial neural network. For example, the activations (a₁₁, a₁₂) received from the first layer L1 which are input to the second layer L2 and the weights (w₂₁, w₂₂, w₂₃, w₂₄, w₂₅, w₂₆), may be data in floating decimal point number format. The quantization system 100 may quantize the activations (a₁₁, a₁₂), and the weights (w₂₁, w₂₂, w₂₃, w₂₄, w₂₅, w₂₆) into data in an integer number format through the quantization process described above. The weighted sum may be calculated using the quantized activations and weights and thus the size of a deep learning model may be reduced and the amount of computations may be reduced. Subsequently, as the activation function is applied to a value of the calculated weighted sum, activations (a₂₁, a₂₂, a₂₃) that are input to the third layer L3 from the second layer L2 may be data in a floating decimal point number format again. That is, the object to be quantized by the quantization system 100 may be parameters of a specific layer or may be parameters corresponding to each of the layers.

FIGS. 3A and 3B are views illustrating a type of quantization method according to an example embodiment.

Specifically, FIG. 3A illustrates an Affine quantization method, and FIG. 3B illustrates a scale quantization method.

Referring to FIG. 3A, in the Affine quantization method, the maximum value and the minimum value of data before being quantized may linearly correspond to the maximum value and the minimum value of a data format to be quantized, respectively. For example, as shown in FIG. 3A, the maximum value (α) of data before being quantized may be 7 and the minimum value (β) of data before being quantized may be −5. When data is quantized into an integer number format of 8 bits, the quantized data may have a value in a range of −128 to 127. According to the Affine quantization method, the maximum value (α) of data before being quantized may correspond to 127 and the minimum value (β) of data before being quantized may correspond to −128. Data values between the maximum value (α) and the minimum value (β) may linearly correspond to data values between 127 and −128. Thus, when the maximum value (α) of data before being quantized and the minimum value (β) of data before being quantized have different values, value 0 before being quantized may correspond to another value that is not 0 after being quantized. In the process of linearly corresponding values, the ratio of the range of values of data after being quantized with respect to the range of values of data before being quantized may be a scale factor. That is, in the Affine quantization method, the scale factor may be calculated as the following [Equation 1].

$$SF ( Scale Factor ) = \frac{{2}^{b} - 1}{α - β} \qquad [ Equation 1 ]$$

In [Equation 1], b represents a number of bits of integer number data after quantization. Referring to the values illustrated in FIG. 3, the scale factor of the Affine quantization method of FIG. 3A may be 255/12.

Referring to FIG. 3B, in the scale quantization method, similarly to the Affine quantization method, the maximum value and the minimum value of data before being quantized may linearly correspond to the maximum value and the minimum value of a data format to be quantized, respectively. However, in the scale quantization method, in order to make the value of 0 before being quantized to correspond to the value of 0 after being quantized, the relationship α=−β may be satisfied. That is, in the scale quantization method, the maximum value (α) of an absolute value of data before being quantized may be obtained, and α and −α may linearly correspond to the maximum value and the minimum value of a data format to be quantized, respectively. In the process of linearly corresponding values, the ratio of the range of values of data after being quantized with respect to the range of values of data before being quantized may be a scale factor. That is, in the scale quantization method, the scale factor may be calculated as the following [Equation 2].

$$SF = \frac{{2}^{b - 1} - 1}{α} \qquad [ Equation 2 ]$$

In [Equation 2], b represents a number of bits of integer number data after quantization. Referring to the values illustrated in FIG. 3, the scale factor of the scale quantization method of FIG. 3b may be 127/7.

In both the quantization methods of FIGS. 3A and 3B, the scale factor may be multiplied by data before being quantized and values obtained by the multiplication may be located in the range of data after being quantized. The quantization method may include a round operation of expressing the result of multiplying the scale factor by data to be quantized in the format of integers, and a clip operation of correcting values that are out of the range, as described below in detail with reference to FIG. 7. In both the quantization methods of FIGS. 3A and 3B, a process of calculating the maximum value and the minimum value of data may be required to calculate or estimate the scale factor. When various data sets are input and scale factors are calculated for all data sets, an excessive amount of computations may be required. As described below, according to an example embodiment, a computation for determining scale factors for all the inputs in a quantization operation during deep learning inference may be omitted and accordingly, the total amount of computations may be reduced.

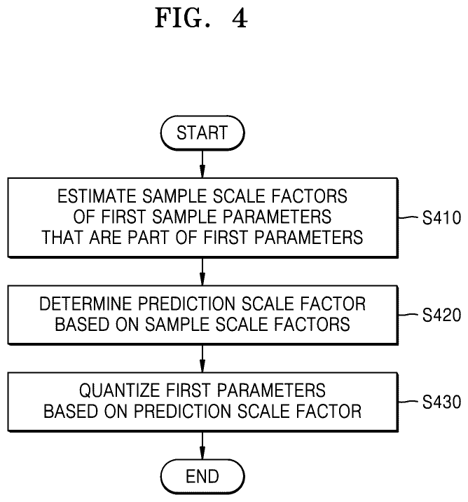

FIG. 4 is a flowchart illustrating a quantization method for an artificial neural network according to an example embodiment.

For example, the quantization method of FIG. 4 may be performed by using the quantization system 100 of FIG. 1. Hereinafter, FIG. 4 will be described with reference to FIG. 1.

Referring to FIG. 4, in operation S410, an operation of estimating sample scale factors of first sample parameters may be performed. The first sample parameters may be part of first parameters. The first parameters may include input variables that are input to a first layer, or weights of the first layer, that are to be quantized. The input variables input to the first layer may be activation outputs from the previous layer of the first layer.

The first sample parameters that are part of the first parameters may be parameters for determining a prediction scale factor to be described below. The first sample parameters may be selected by sampling part of input first parameters (not a pre-defined sample). For example, when the input first parameters include A number of data sets, the first sample parameters may include first B number of data sets of the input first parameters (where B is a natural number less than natural number A). That is, in an example embodiment, the first sample parameters may refer to a series (e.g., consecutive) of first parameters input among the first parameters. The first B number of data sets of the input first parameters may be first sample parameters, and an operation of estimating or calculating a scale factor about each of the first sample parameters may be performed on the first B number of data sets of the input first parameters. The scale factor corresponding to the first sample parameter may be estimated by using the method described above with reference to FIGS. 1 through 3. For example, when the input data set IN is input as the first sample parameter as shown in FIG. 1, the maximum value or the minimum value in the data set may be obtained and the scale factor may be calculated or estimated based thereon, as described above with reference to FIG. 3. In order to obtain the maximum value or the minimum value in the data set, a comparator may be utilized or a comparison operation may be performed, as described below in detail with reference to FIG. 7.

Referring to FIG. 4, in operation S420, an operation of determining a prediction scale factor based on sample scale factors may be performed. In the previous operation S410, after sample scale factors are estimated for the first sample first parameters, a prediction scale factor that may represent all first parameters may be determined based on the sample scale factors. As described above, when scale factors are calculated for all of parameters, an excessive amount of computations may be required. Thus, in the quantization method of the present disclosure, the prediction scale factor may be utilized in a quantization calculation. In a method of determining the prediction scale factor based on the sample scale factors, various equations may be utilized, and different equations may be selected according to the characteristics or relation of data sets. The method of determining the prediction scale factor according to an example embodiment may use the following [Equation 3].

$$PSF ( Prediction Scale Factor ) = \frac{PSF + SF}{2} \qquad [ Equation 3 ]$$

[Equation 3] is a computational equation to be performed by a computer and/or program, and is a computational equation indicating a computation method of the prediction scale factor PSF as the sample scale factors SF are sequentially input to the quantizer 140. In [Equation 3], specifically, the prediction scale factor may be calculated by reflecting an exponential moving average. [Equation 3] shows the case where a proportional coefficient is ½, in the computation method of the prediction scale factor PSF, and embodiments are not limited to [Equation 3]. Another example formula based on [Equation 3] is shown in Equation 4 below.

$$PSF = ( 1 - k ) \cdot PSF + k \cdot SF \qquad [ Equation 4 ]$$

[Equation 4] is a computational equation to be performed by a computer and/or program, and is a computational equation indicating a computation method of the prediction scale factor PSF as the sample scale factors SF are sequentially input to the quantizer 140. k is a real number between 0 and 1, and the larger the value k is, the larger the effect of a previous observation value may be reduced. When k is ½, [Equation 3] is established.

The method of determining the prediction scale factor according to another example embodiment may use the following [Equation 5].

$$PSF = \frac{SF}{( Number of Sample )} \qquad [ Equation 5 ]$$

[Equation 5] is a computational equation to be performed by a computer and/or program, and is a computational equation indicating a computation method of the prediction scale factor PSF as the sample scale factors SF are sequentially input to the quantizer 140. In [Equation 5], specifically, the prediction scale factor may be calculated by reflecting an arithmetic mean.

The method of determining the prediction scale factor according to another example embodiment may use the following [Equation 6].

$$PSF = min ( PSF , SF ) \qquad [ Equation 6 ]$$

[Equation 6] is a computational equation to be performed by a computer and/or program, and is a computational equation indicating a computation method of the prediction scale factor PSF as the sample scale factors SF are sequentially input to the quantizer 140. In [Equation 6], specifically, the prediction scale factor may be calculated by reflecting the minimum value of the sample scale factor.

The method of determining the prediction scale factor according to another example embodiment may use the following [Equation 7].

$$PSF = max ( PSF , SF ) \qquad [ Equation 7 ]$$

[Equation 7] is a computational equation to be performed by a computer and/or program, and is a computational equation indicating a computation method of the prediction scale factor PSF as the sample scale factors SF are sequentially input to the quantizer 140. In [Equation 7], specifically, the prediction scale factor may be calculated by reflecting the maximum value of the sample scale factor.

Equations such as [Equation 3] to [Equation 7] may be calculated by calculating the sample scale factors sequentially for sample parameters input in the sequence in time, and reflecting the sample scale factors sequentially calculated in the prediction scale factor value accumulatively. In this case, the sample scale factor that is firstly calculated (or estimated) may be determined as an initial prediction scale factor. In addition, after sample scale factors corresponding to sample parameters are calculated, a prediction scale factor value may also be calculated based on all of sample scale factors.

Through equations such as [Equation 3] to [Equation 7], in operation S420, an operation of determining a prediction scale factor based on the sample scale factors may be performed. However, this is only an example equation, and a method of determining the prediction scale factor based on the sample scale factors is not limited thereto. For example, a value of the prediction scale factor calculated from the sample scale factors may be adjusted by adding or multiplying a proper coefficient to Equations such as [Equation 3] to [Equation 7]. In addition, the value of the prediction scale factor may also be calculated by combining a plurality of equations including one or more of the above equations. By utilizing an appropriate equation, a quantization operation, in which accuracy may be secured while reducing the amount of computations of the artificial neural network, may be performed.

Referring to FIG. 4, in operation S430, an operation of quantizing first parameters based on the prediction scale factor may be performed. The quantization operation may be performed by the operation of the quantizer 140 of FIG. 1 and may also be performed by a quantization apparatus including the configuration of FIG. 7, which will be described below. A method of quantizing first parameters may include the Affine quantization method or the scale quantization method described above with reference to FIG. 3. Specifically, the prediction scale factor calculated in the previous operation S420 may be a factor calculated instead of a process of calculating scale factors for all parameters and may be used in a quantization process of the first parameters. Instead of calculating the scale factor of each of the first parameters, the calculated prediction scale factor may be used to quantize the first parameters. According to the above-described embodiment, by using the prediction scale factor, a computation for determining scale factors for all of inputs in a quantization operation during deep learning inference may be omitted and accordingly, the total amount of computations may be reduced. In addition, computing resources for implementing an artificial neural network based on the quantized artificial neural network having high accuracy may be reduced, and the application range of the artificial neural network may be extended.

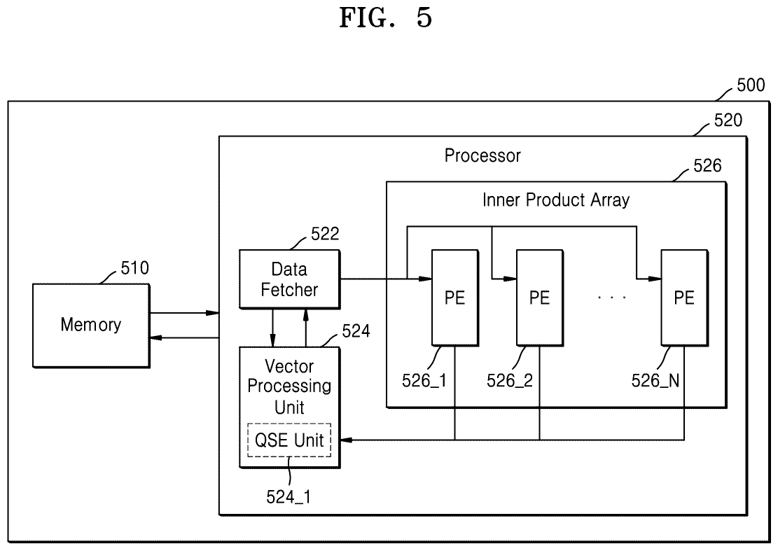

FIG. 5 is a block diagram illustrating a quantization apparatus for an artificial neural network according to an example embodiment.

Referring to FIG. 5, a quantization apparatus 500 for the artificial neural network may include a memory 510 and a processor 520. Hereinafter, FIG. 5 will be described with reference to FIGS. 1 and 4, and redundant descriptions with descriptions with reference to the previous drawings are omitted.

The memory 510 of the quantization apparatus 500 may store a program for quantization for the artificial neural network according to an example embodiment and may store activation or data quantized by the quantization method. In addition, the memory 510 may store the quantized output data set OUT of FIG. 1 and may store bias or data generated in a quantization process. The memory 510 may store a series of commands related to performance of quantization. The memory 510 may communicate with the processor 520 to exchange data with each other.

The processor 520 may be one or more of a Central Processing Unit (CPU), a Graphics Processing Unit (GPU), and a Neural Processing Unit (NPU). However, this is an example, and the processor 520 is not limited to the description above. The processor 520 illustrated in FIG. 5 may include a data fetcher 522, a vector processing unit 524, and an inner product array 526. The data fetcher 522 may receive data such as weights, activation, bias or the like from the memory 510 and may transmit the data to the vector processing unit 524. The vector processing unit 524 may include a Quantization with Scale factor Estimation (QSE) unit 524_1 therein. The illustration of FIG. 5 is an example, and the QSE unit 524_1 may function independently outside the vector processing unit 524. The QSE unit 524_1 may obtain a prediction scale factor corresponding to parameters such as input weights, activation, and the like and may perform quantization based on the prediction scale factor. A detailed operation of the QSE unit 524_1 will be described below with reference to FIG. 7.

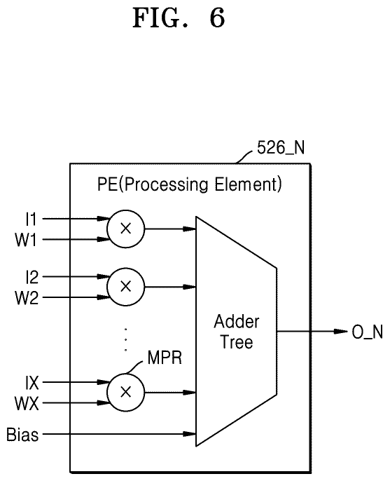

The vector processing unit 524 may transmit quantized parameters to the data fetcher 522, and the data fetcher 522 may transmit the quantized parameters to the inner product array 526. The inner product array 526 may calculate a weighted sum based on data such as the input quantized weights, quantized activation, quantized bias, and the like. FIG. 5 illustrates that the quantization apparatus 100 includes N processing units 526_1, 526_2, . . . 526_N. However, this is an example, and the quantization apparatus 100 may also include processing units PE in different numbers. The processing unit PE may calculate a weighted sum between quantized weights and quantized activations, and a detailed operation of the processing unit PE will be described below in detail with reference to FIG. 6. When calculating the weighted sum based on unquantized parameters, the inner product array 526 requires a large amount of computations, and much time and many resources may be required in an interference operation of deep learning. According to an example embodiment, a computation for estimating scale factors for all of inputs in a quantization operation during deep learning inference may be omitted and accordingly, the total amount of computations may be reduced.

Data such as activations output through the inner product array 526 may be transmitted to the vector processing unit 524, and the vector processing unit 524 may receive additional data from the data fetcher 522 to perform a quantization operation of the next layer. In addition, the vector processing unit 524 may transmit the output activation data transmitted from the inner product array 526 to the memory 510 so as to store the output activation data.

Although not shown in FIG. 5, the configuration of a buffer or a register for storing data therein may be additionally included, and the configuration such as an adder, a multiplexer of selecting or adding data, may be additionally included.

FIG. 6 is a block diagram illustrating a processing device inside the quantization apparatus 500 of FIG. 5 according to an example embodiment.

Referring to FIGS. 5 and 6, the inner product array 526 included in the apparatus 500 may include a plurality of processing devices PE, 526_1, 526_2, . . . 526_N. Each of the processing devices PE, e.g., 526_N as illustrated in FIG. 6, may include a plurality of multipliers MPR and an adder tree. The processing devices PE 526_N may perform the computation shown in the following [Equation 8].

$$y = {\sum }_{k = 1}^{X} {I}_{k} {W}_{k} + Bias \qquad [ Equation 8 ]$$

In [Equation 8], I represents an input quantized activation, W represents an input quantized weight, Bias represents a bias, and y represents an output. The processing device PE 526_N may receive X number of quantized activations, quantized weights corresponding to the quantized activations, and a bias. X may represent a number of channels of a layer on which computation is performed and may have different values for each layer. In addition, FIG. 6 illustrates that X number of multipliers MPR are present. However, this is an example, and the processing devices PE 526_N may include different numbers of multipliers MPR according to the hardware specification. Quantized activations and quantized weights multiplied by multipliers may be added by the adder tree along with a bias. As a result, the processing devices PE 526_N may calculate a weighted sum by receiving X quantized activations, quantized weights, and a bias value.

Although not shown in FIG. 6, the processing devices PE 526_N according to an example embodiment may include a register or a memory for storing data according to embodiments, and may additionally include a component for applying an activation function.

FIG. 7 is a block diagram illustrating a QSE unit inside the quantization apparatus of FIG. 5 according to an example embodiment.

Referring to FIGS. 5 and 7, the vector processing unit 524 inside the quantization apparatus 500 may include a QSE unit 524_1. The QSE unit 524_1 may include a scale factor estimator 710 and a quantizer 720. The scale factor estimator 710 and the quantizer 720 may be examples of the estimator 120 and the quantizer 140 of FIG. 1 and may perform partially common functions. Regarding the operation of the quantization method, redundant descriptions with the descriptions of FIGS. 1 and 4 are omitted.

The QSE unit 524_1 may perform scale factor estimation and quantization of parameters such as activations, weights, and the like. The QSE unit 524_1 may receive first parameters and may output quantized parameters. In this case, each of the parameters may refer to data sets, and each of the data sets may include N data. For example, in the case of an image having 3×3 pixels, one image data set may include 9 pieces of data corresponding to 9 pixels, and in a quantization operation in a first layer, N may be 9. In this case, each of the first parameters may include 9 pieces of data, and the QSE unit 524_1 may receive input data 0_1, 0_2, . . . , and 0_N that constitutes one input parameter and may output quantized output data Q_1, Q_2, . . . , and Q_N. The quantized output data Q_1, Q_2, . . . , and Q_N may constitute one quantized output parameter. That is, the input and output operations illustrated in FIG. 7 are operations corresponding to one parameter, that is, one data set. For example, when 1,000 images, each image having 3×3 pixels, are processed, the first layer may receive 9 pieces of input data 0_1, 0_2, . . . , and 0_N and may output quantized output data Q_1, Q_2, . . . , and Q_N, with respect to one image. In addition, input and output of corresponding data may be performed on the 1,000 images.

The scale factor estimator 710 inside the QSE unit 524_1 may estimate sample scale factors of first sample parameters. The first sample parameters may be part of first parameters. In an embodiment, the QSE unit 524_1 may estimate a scale factor for only part of the first parameters to be quantized and skip estimating a scaling factor for the other part of the first parameters. As described above with reference to FIG. 4, the first sample parameters according to an example embodiment may refer to a certain number of first parameters among the first parameters. The first sample parameters may be consecutive first parameters and may be a group of first parameters that first appears. For each of the first sample parameters, the scale factor estimator 710 may calculate the maximum value and the minimum value of a sample parameter by using a plurality of comparators CPRs to estimate a sample scale factor for the corresponding sample parameter. As described above with reference to FIGS. 3A and 3B, the scale factor estimator 710 may calculate a sample scale factor based on the maximum value and the minimum value calculated through the plurality of comparators CPRs.

The scale factor estimator 710 may include a register 711 configured to store a sample scale factor and a prediction scale factor therein. The scale factor estimator 710 may calculate the sample scale factor of each first sample parameter by using the plurality of comparators CPRs described above until B number of first sample parameters, e.g., B data sets, are input to the scale factor estimator 710. A value of B may be preset. The calculated sample scale factors may be delivered to the quantizer 720 and may be stored in the register 711. The scale factor estimator 710 may calculate the prediction scale factor based on equations such as [Equation 3] through [Equation 6] and the calculated sample scale factors, as described above with reference to FIG. 4.

After all of first sample parameters, e.g., B data sets, are input to the QSE unit 524_1, the register 711 of the scale factor estimator 710 may calculate and store the prediction scale factor. Subsequently, when additional first parameters are input to the QSE unit 524_1, the scale factor estimator 710 may not perform computations for calculating the maximum value or the minimum value through a comparison computation between pieces of data of each of the additional first parameters. That is, the scale factor estimator 710 may output the prediction scale factor stored in the register 711 to the quantizer 720, without estimating the scale factor according to an input of the first parameters, after calculation of the prediction scale factor is completed. Scale factor computation may not be performed on all parameters, e.g., all data sets, and a quantization computation may be performed using the prediction scale factor. Thus, according to an example embodiment, a computation for estimating scale factors for all of inputs in a quantization operation during deep learning inference may be omitted and accordingly, the total amount of computations may be reduced.

The quantizer 720 may output quantized output data Q_1, Q_2, . . . , and Q_N after input data O_1, O_2, . . . , and O_N and the scale factor SF from the scale factor estimator 710 are input to the quantizer 720. In a section where the first sample parameters are input to the quantizer 720, the calculated sample scale factor may be input from the scale factor estimator 710 to the quantizer 720. FIG. 7 shows that the scale factor SF is input to the quantizer 720. However, this is a comprehensive notation, and after the calculation of the predictive scale factor is completed, as described above, the prediction scale factor stored in the register 711 may be input to the quantizer 720. That is, while first sample parameters are input, the sample scale factor corresponding to each of the first sample parameters may be sequentially input to the quantizer 720 through a series of calculations of the scale factor estimator 710. After all of sample parameters are input, the prediction scale factor may be calculated and stored in the register 711 and may be input to the quantizer 720.

The quantizer 720 may multiply the prediction scale factor by each of the input data O_1, O_2, . . . , and O_N, through multipliers MPR. Subsequently, the quantizer 720 may round the multiplied value and may output finally quantized output data Q_1, Q_2, . . . , and Q_N through a clip calculation. A round calculation unit in the quantizer 720 may indicate the output data in the form of integer numbers.

Calculation of the clip calculation unit may be expressed as [Equation 9].

$$clip ( x , l , u ) = \{ \begin{matrix}l ( if x < l ) \\ x ( if l \leq x < u ) \\ u ( if u < x )\end{matrix} \qquad [ Equation 9 ]$$

In [Equation 9], x is an input data value, 1 is the minimum value of quantized data to be expressed, and u is the maximum value of quantized data to be expressed. The clip calculation unit in the quantizer 720 may adjust a data value such that the output data may be between the maximum value and the minimum value.

According to the above-described embodiment, a computation for estimating scale factors of all of inputs in a quantization operation during deep learning inference may be omitted and accordingly, the total amount of computations may be reduced. In addition, computing resources for implementing an artificial neural network based on the quantized artificial neural network having high accuracy may be reduced, and the application range of the artificial neural network may be extended.

Herein, the scale factor estimator 710 and the quantizer 710 may each be analog and/or digital circuits including one or more of a logic gate, an integrated circuit, a microprocessor, a microcontroller, a memory circuit, a passive electronic component, an active electronic component, an optical component, and the like, and may be configured to execute software and/or firmware to perform the corresponding functions or operations described above.

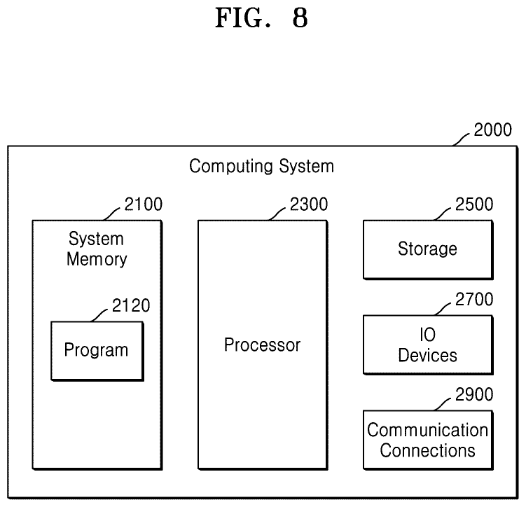

FIG. 8 is a block diagram illustrating a computing system 2000 according to an example embodiment.

In some embodiments, the quantization system 100 of FIG. 1 and/or the quantization apparatus 500 of FIG. 5 may be implemented in the computing system 2000 of FIG. 8. As shown in FIG. 8, the computing system 2000 may include a system memory 2100, a processor 2300, a storage 2500, input/output devices 2700, and communication connections 2900. Components included in the computing system 2000 may be communicatively connected to one another via a bus, for example.

The system memory 2100 may include a program 2120. The program 2120 may allow the processor 2300 to perform quantization of an artificial neural network according to example embodiments. For example, the program 2120 may include a plurality of commands executable by the processor 2300, and the plurality of commands included in the program 2120 may be executed by the processor 2300 such that quantization of the artificial neural network may be performed. The system memory 2100 that is a non-limiting example, may include a volatile memory such as a Static Random Access Memory (SRAM) and a Dynamic Random Access Memory (DRAM), or a nonvolatile memory such as a flash memory, etc.

The processor 2300 may include at least one core for executing arbitrary command sets (e.g., Intel Architecture-32 (IA-32), 64-bit extension IA-32, x86-64, PowerPC, Sparc, MIPS, ARM, IA-64, etc.). The processor 2300 may execute the commands stored in the system memory 2100 and may execute the program 2120 such that quantization of the artificial neural network may be performed.

The storage 2500 may not lose the stored data even if power supplied to the computing system 2000 is blocked. For example, the storage 2500 may include a non-volatile memory such as an Electrically Erasable Programmable Read-Only Memory (EEPROM), a flash memory, a Phase Change Random Access Memory (PRAM), a Resistance Random Access Memory (RRAM), a Nano Floating Gate Memory (NFGM), a Polymer Random Access Memory (PoRAM), a Magnetic Random Access Memory (MRAM), a Ferroelectric Random Access Memory (FRAM), or a storage medium such as a magnetic tape, an optical disc, a magnetic disc, or the like. In some embodiments, the storage 2500 may be detachable from the computing system 2000.

In some embodiments, the storage 2500 may store the program 2120 for quantization of the artificial neural network according to an example embodiment, and before the program 2120 is executed by the processor 2300, the program 2120 or at least a part thereof may be loaded into the system memory 2100 from the storage 2500. In some embodiments, the storage 2500 may store files written in program languages, and the program 2120 generated by a compiler or the like or at least a part thereof may be loaded into the system memory 2100 from the files.

In some embodiments, the storage 2500 may store data to be processed by the processor 2300 and/or data processed by the processor 2300. For example, the storage 2500 may store quantized activations or data according to the quantization method described above, may store the quantized output data set OUT of FIG. 1, or may store a bias or data generated in quantization.

The input/output devices 2700 may include an input device such as a keyboard, a pointing device, or the like and may include an output device such as a display device, a printer, or the like. For example, the user may trigger execution of the program 2120 by the processor 2300, may input the input data of FIG. 2 (e.g., I₁, I₂), or may check the quantized output data set OUT of FIG. 1 and/or an error message through the input/output devices 2700.

The communication connections 2900 may provide access about a network outside the computing system 2000. For example, the network may include a plurality of computing systems and communication links, and the communication links may include wired links, optical links, wireless links or links having other arbitrary formats.

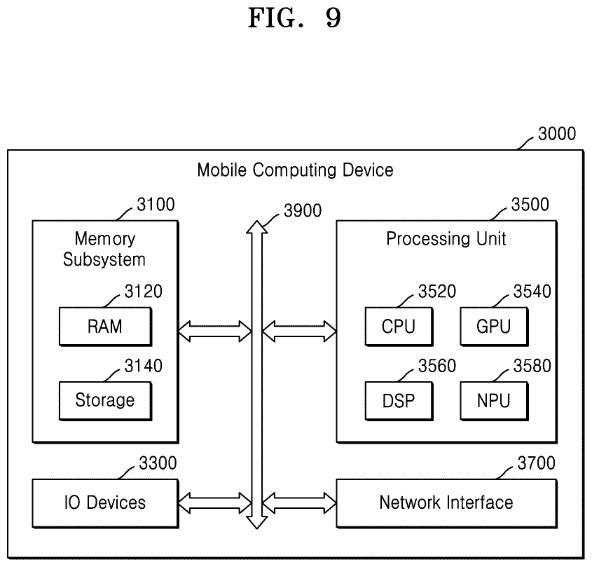

FIG. 9 is a block diagram illustrating a portable computing system according to an example embodiment.

In some embodiments, the quantized artificial neural network according to an example embodiment may be implemented in a portable computing device 3000. The portable computing device 3000 that is a non-limiting example may be any portable electronic device that supplies power through battery or self-power, such as mobile phones, tablet personal computers (PCs), wearable devices, and Internet of Things (IoT) devices.

As shown in FIG. 9, the portable computing device 3000 may include a memory subsystem 3100, input/output devices 3300, a processing unit 3500, and a network interface 3700. The memory subsystem 3100, the input/output devices 3300, the processing unit 3500, and the network interface 3700 may communicate with one another via a bus 3900. In some embodiments, at least two of the memory subsystem 3100, the input/output devices 3300, and the processing unit 3500, and the network interface 3700 may be included in one package as a System-on-a-Chip (SoC).

The memory subsystem 3100 may include a random access memory (RAM) 3120 and a storage 3140. The RAM 3120 and/or the storage 3140 may store commands to be executed by the processing unit 3500 and data to be processed by the processing unit 3500. For example, the RAM 3120 and/or the storage 3140 may store variables such as signals, weights, biases of the artificial neural network and may also store parameters of an artificial neuron (or a calculation node) of the artificial neural network. In some embodiments, the storage 3140 may include non-volatile memory.

The processing unit 3500 may include a CPU 3520, a GPU 3540, a Digital Signal Processor (DSP) 3560, and an NPU 3580. Unlike in FIG. 9, in some embodiments, the processing unit 3500 may include only at least part of the CPU 3520, the GPU 3540, the DSP 3560, and the NPU 3580.

The CPU 3520 may control an overall operation of the portable computing device 3000, and perform a specific work itself, or may direct other components of the processing unit 3500 to perform the specific work in response to, for example, an external input received through the input/output devices 3300. The GPU 3540 may generate data for an image to be output through a display apparatus included in the input/output devices 3300 or may encode data received from a camera included in the input/output devices 3300. The DSP 3560 may process digital signals, for example, digital signals provided from the network interface 3700 such that valid data may be generated.

The NPU 3580 that is executive hardware for the artificial neural network may include a plurality of calculation nodes corresponding to at least part of artificial neurons that constitute the artificial neural network, and at least part of the plurality of calculation nodes may process signals in a parallel manner. According to an example embodiment, the quantized artificial neural network, such as a deep neural network, has a high accuracy as well as low computational complexity and thus may be easily implemented in the portable computing device 3000 of FIG. 9, and the quantized artificial neural network has fast processing speed and may be implemented by the NPU 3580 that is simple and small, for example.

The input/output devices 3300 may include input devices such as a touch input device, a sound input device, a camera, and the like, and output devices such as a display device, a sound output device, and the like. The network interface 3700 may provide access about a mobile communication network such as Long Term Evolution (LTE), 5th Generation (5G), and the like, to the portable computing device 3000, and may also provide access about a local network such as Wireless Fidelity (WiFi).

While the inventive concept has been particularly shown and described with reference to example embodiments thereof, it will be understood that various changes in form and details may be made therein without departing from the spirit and scope of the following claims and their equivalents.

What is claimed is:

1. A quantization method for an artificial neural network for interference acceleration, the quantization method comprising:
estimating sample scale factors of first sample parameters, the first sample parameters being part of first parameters within the artificial neural network;
determining a prediction scale factor based on the sample scale factors; and
quantizing the first parameters based on the prediction scale factor.

2. The quantization method of claim 1, wherein the first parameters comprise input variables that are input to a first layer and weights of the first layer within the artificial neural network.

3. The quantization method of claim 1, wherein the determining the prediction scale factor comprises determining the prediction scale factor based on an exponential moving average of the sample scale factors.

4. The quantization method of claim 1, wherein the determining the prediction scale factor comprises determining the prediction scale factor based on an arithmetic mean of the sample scale factors.

5. The quantization method of claim 1, wherein the determining the prediction scale factor comprises determining the prediction scale factor based on a maximum value or a minimum value of the sample scale factors.

6. The quantization method of claim 1, wherein the quantizing the first parameters comprises:
quantizing the first parameters through Affine quantization or scale quantization.

7. The quantization method of claim 6, wherein the quantizing of the first parameters comprises:
quantizing the first parameters by using the prediction scale factor instead of respective scale factors of the first parameters.

8. A quantization system for an artificial neural network for interference acceleration, the quantization system comprising:
at least one processor; and
a storage medium configured to store commands executable by the at least one processor to perform a quantization process of the artificial neural network,
wherein the quantization process of the artificial neural network comprises:
estimating sample scale factors of first sample parameters, the first sample parameters being part of first parameters within the artificial neural network;
determining a prediction scale factor based on the sample scale factors; and
quantizing the first parameters based on the prediction scale factor.

9. The quantization system of claim 8, wherein the first parameters comprise input variables that are input to a first layer and weights of the first layer within the artificial neural network.

10. The quantization system of claim 8, wherein the determining the prediction scale factor comprises determining the prediction scale factor based on an exponential moving average of the sample scale factors.

11. The quantization system of claim 8, wherein the determining the prediction scale factor comprises determining the prediction scale factor based on an arithmetic mean of the sample scale factors.

12. The quantization system of claim 8, wherein the determining the prediction scale factor comprises determining the prediction scale factor based on a maximum value or a minimum value of the sample scale factors.

13. The quantization system of claim 8, wherein the quantizing the first parameters comprises quantizing the first parameters through Affine quantization or scale quantization.

14. The quantization system of claim 8, wherein the at least one processor is configured to perform the quantization process of the artificial neural network in real time as initial data is input to the at least one processor.

15. A quantization apparatus for an artificial neural network for interference acceleration, the quantization apparatus comprising:
a scale factor estimator configured to estimate sample scale factors of first sample parameters, the first sample parameters being part of first parameters within the artificial neural network, and configured to determine a prediction scale factor based on the sample scale factors; and
a quantizer configured to quantize the first parameters based on the prediction scale factor.

16. The quantization apparatus of claim 15, wherein the first parameters comprise input variables that are input to a first layer and weights of the first layer within the artificial neural network.

17. The quantization apparatus of claim 15, wherein the prediction scale factor is determined based on an exponential moving average or an arithmetic mean of the sample scale factors.

18. The quantization apparatus of claim 15, wherein the prediction scale factor is determined based on a maximum value or a minimum value of the sample scale factors.

19. The quantization apparatus of claim 15, wherein the quantizer is configured to quantize the first parameters through Affine quantization or scale quantization.

20. The quantization apparatus of claim 19, wherein the quantizer is configured to quantize the first parameters by using the prediction scale factor instead of respective scale factors of the first parameters.
